(19) United States
(12) Patent Application Publication
(10) Pub. No.: US 2020/0276852 A1
(43) Pub. Date: Sep. 3, 2020

(54) BOOK ARRANGEMENT AND METHOD OF USE THEREOF

(71) Applicant: DELICIOUS LTD [BS/BS], Nassau (BS)

(72) Inventor: Gerry DeVeaux, Cambridge (GB)

(21) Appl. No.: 16/645,550

(22) PCT Filed: Sep. 7, 2018
(86) PCT No.: PCT/IB2018/056843

§ 371 Date: Mar. 9, 2020

(30) Foreign Application Priority Data
Sep. 7, 2017 (GB) 1714428.8
Oct. 12, 2017 (GB) 1716752.9

(51) Int. Cl. B42D 1/00; B42D 3/12; G06K 7/14; G06F 9/451

(52) U.S. Cl. CPC B42D 1/007; B42D 3/12; G09B 3/00; G06F 9/451; B42P 2241/16; G06K 7/1439

(57) ABSTRACT

There is provided a book arrangement and a method of use thereof. The book arrangement includes a printed book for providing primary content, one or more mobile communication devices, and a remote database arrangement couplable via data communication network to one or more mobile communication devices. Moreover, the one or more mobile communication devices each include data processing hardware and data memory therein. Furthermore, the book arrangement includes a sensor arrangement for detecting a given page of the printed book being viewed or read by a user and generating corresponding sensed data. The data processing hardware and the data memory of the one or more mobile communication devices is configured to process sensed data to determine the given page, and to fetch corresponding supplementary content from the data memory and/or the remote database arrangement for presenting to the user on a graphical user interface of the one or more mobile communication devices.

### TECHNICAL FIELD

The present disclosure relates generally to book arrangements, and more specifically, to book arrangements that are configured to provide interactive reading experience for users thereof. Moreover, the present disclosure relates to methods of (for) using aforesaid book arrangements. Moreover, the present disclosure relates to methods of manufacturing aforesaid book arrangements. Furthermore, the present disclosure also relates to software products recorded on machine-readable non-transient data storage media, wherein the software products are executable upon computing hardware to implement the aforesaid method of (for) using and/or the aforesaid method of (for) manufacturing.

### BACKGROUND

Traditionally, an activity of reading has played a vital role in human societal evolution. Moreover, such an activity of reading books has been responsible for a sense of social awareness and understanding among human populations. In modern history, books have been catalysts for social change. Furthermore, books provide a great deal of knowledge about past civilizations and cultures.

In recent times, books are used for self-development, educational and recreational purposes. Moreover, books targeted towards children and young adults have been increasingly prevalent recently. Furthermore, printed books. Moreover, electronic books may provide a wider range of content that may be easier to implement on an electronic medium. Furthermore, interactive reading software may be implemented on portable devices, such as electronic readers or more commonly, on smart phones, tablets computers and laptop computers. Such interactive reading software may be implemented as software applications (commonly referred to as “apps”), wherein the given user may interact with such a software application on a portable device.

Despite advancements in aforementioned electronic books, users may prefer to read a conventional printed book that they can physically hold, turn pages by hand and potentially write upon. Such preference of the users is based on the experience provided by a conventional printed book. However, such conventional printed books may not provide a degree of user interaction akin to the electronic books. Furthermore, content provided in conventional printed books (and, electronic books) may get repetitive on repeated readings (or, viewings) thereof and thereby diminish the overall experience of the book.

Therefore, in light of the foregoing elucidation, there exists a need to address, for example overcome, the aforementioned drawbacks associated with conventional printed and electronic books.

### SUMMARY

The present disclosure seeks to provide a book arrangement that has characteristics of a book printed on paper, but is configured to provide interactive electronic functionality to a given user of the book arrangement.

Moreover, the present disclosure also seeks to provide a method of using the aforesaid book arrangement.

According to a first aspect, an embodiment of the present disclosure provides a book arrangement including a printed book having a plurality of printed pages for providing primary content, one or more mobile communication devices, and a remote database arrangement couplable via a data communication network to the one or more mobile communication devices, wherein the one or more mobile communication devices each include data processing hardware and data memory therein, characterized in that the book arrangement includes a sensor arrangement for detecting a given page of the printed book, or a portion of a given page of the printed book, being viewed or read by a user and generating corresponding sensed data, wherein the data processing hardware and the data memory of the one or more mobile communication devices is configured to process the sensed data to determine the given page, or the portion of the given page of the printed book, and to fetch corresponding supplementary content from the data memory and/or the remote database arrangement for presenting to the user on a graphical user interface (GUI) of the one or more mobile communication devices.

The present disclosure is of advantage in that there is provided a book arrangement that is configured to provide improved interactive reading with users; furthermore, the book arrangement is configured to provide enhanced interest and enjoyment to the user.

Optionally, the sensor arrangement includes at least one of: optical sensors, resonant inductive sensors, graphical images readable using optical sensors, resonant inductive structures readable using resonant inductive sensors.

Optionally, the sensor arrangement is configured to employ one or more image sensors of the one or more mobile communication devices, including interactive wearable items and screens, for providing the sensed data, wherein the data processing hardware and the data memory of the one or more mobile communication devices is configured to compare the sensed data against reference data to determine the given page.

Optionally, the data processing hardware and the data memory of the one or more mobile communication devices is configured to compare the sensed data against reference data to determine the given page, by comparing metadata describing the sensed data against reference metadata.

More optionally, the sensor arrangement includes a coil arrangement for detecting resonances by electromagnetically interrogating one or more resonant circuits included on the one or more pages, wherein the one or more resonant circuits are indicative of supplementary content being available for regions of pages of the printed book whereat the one or more resonant circuit are included.

Optionally, the one or more resonant circuits are implemented by employing inductors that are fabricated by using printed conductive ink or conductive polymer.

Optionally, the one or more resonant circuits are implemented by using one or more labels including the one or more resonant circuits, wherein the one or more labels are adhesively attachable to the plurality of pages and/or at least one of a front cover and back cover of the printed book.

More optionally, the printed book has a front cover and a back cover provided with the coil arrangement for interrogating the one or more resonant circuits, to determine the given page at which the printed book is open when in use. Optionally, both the front cover and the back cover are provided with the coil arrangement. Alternatively, either the front cover or the back cover are provided with the coil arrangement.

Optionally, the coil arrangement is included on pages immediate proximate to the back cover and/or the front cover.

According to a second aspect, an embodiment of the present disclosure provides a printed book that is useable with the aforementioned book arrangement.

According to a third aspect, an embodiment of the present disclosure relates to methods of manufacturing the aforementioned printed book.

Optionally, the front cover and the back cover of the printed book is manufactured from at least one of: leather, suede, moleskin, plastic, velvet.

According to a fourth aspect, an embodiment of the present disclosure provides a method of using a book arrangement including a printed book having a plurality of printed pages for providing primary content, one or more mobile communication devices, and a remote database arrangement couplable via a data communication network to the one or more mobile communication devices, wherein the one or more mobile communication devices each include data processing hardware and data memory therein, characterized in that the method includes:
(i) employing a sensor arrangement of the book arrangement for detecting a given page of the printed book, or a portion of a given page of the printed book, being viewed or read by a user and generating corresponding sensed data; and
(ii) using the data processing hardware and the data memory of the one or more mobile communication devices to process the sensed data to determine the given page, or the portion of the given page of the printed book, and to fetch corresponding supplementary content from the data memory and/or the remote database arrangement for presenting to the user on a graphical user interface (GUI) of the one or more mobile communication devices.

Optionally, the method includes arranging for the sensor arrangement to include at least one of: optical sensors, resonant inductive sensors, graphical images readable using optical sensors, resonant inductive structures readable using resonant inductive sensors.

Optionally, the method includes configuring the sensor arrangement to employ one or more image sensors of the one or more mobile communication devices for providing the sensed data, wherein the data processing hardware and the data memory of the one or more mobile communication devices is configured to compare the sensed data against reference data to determine the given page, or the portion of the given page of the printed book.

Optionally, the method includes configuring the data processing hardware and the data memory of the one or more mobile communication devices to compare the sensed data against reference data to determine the given page, or the portion of the given page of the printed book, by comparing metadata describing the sensed data against reference metadata.

More optionally, the method includes arranging for the sensor arrangement to include a coil arrangement for detecting resonances by electromagnetically interrogating one or more resonant circuits included on the one or more pages, wherein the one or more resonant circuits are indicative of supplementary content being available for regions of pages of the printed book whereat the one or more resonant circuit are included.

Yet more optionally, the method includes implementing the one or more resonant circuits by employing inductors that are fabricated by using printed conductive ink or conductive polymer.

Optionally, the method includes implementing the one or more resonant circuits by using one or more labels including the one or more resonant circuits, wherein the one or more labels are adhesively attachable to the plurality of pages and/or at least one of a front cover and back cover of the printed book.

Optionally, the method includes implementing printing on the front and back cover using conductive ink, wherein front and back cover of the printed book are manufactured using at least one of: leather, suede, moleskin, plastic, velvet.

According to a fifth aspect, embodiments of the present disclosure provide a software product recorded on machine-readable non-transient data storage media, wherein the software product is executable upon computing hardware for implementing the aforementioned method.

It will be appreciated that features of the present disclosure are susceptible to being combined in various combinations without departing from the scope of the present disclosure as defined by the appended claims.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a book arrangement, in accordance with an embodiment of the present disclosure;

FIG. 2 is a schematic illustration of an implementation of the book arrangement, in accordance with an embodiment of the present disclosure;

FIG. 3 is a schematic illustration of a printed book, in accordance with an embodiment of the present disclosure; and

FIG. 4 is an illustration of steps of a method of using the book arrangement, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible

In overview, embodiments of the present disclosure are concerned with a book arrangement that has characteristics of a book printed on paper, but is configured to provide interactive electronic functionality to a given user of the book arrangement.

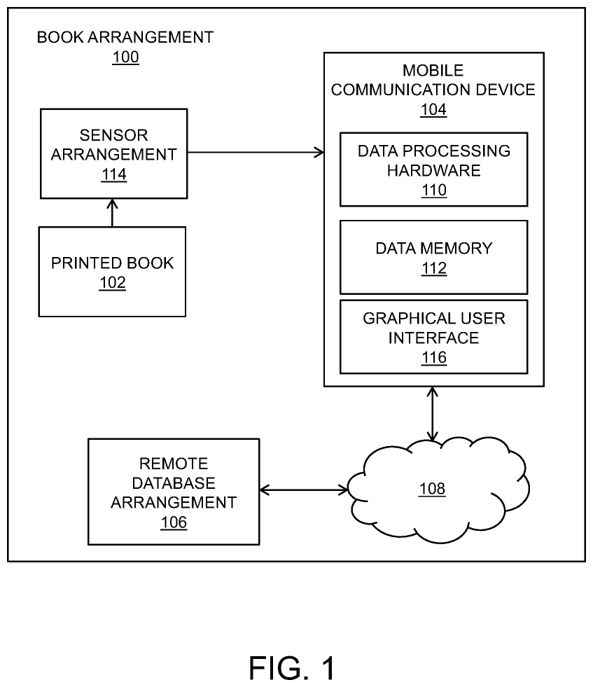

Referring to FIG. 1, there is shown a schematic illustration of a book arrangement 100, in accordance with an embodiment of the present disclosure. The book arrangement 100 includes a printed book 102 having a plurality of pages for providing primary content, one or more mobile communication devices, such as the mobile communication device 104, and a remote database arrangement 106 couplable via a data communication network 108 to the one or more mobile communication devices, such as the mobile communication device 104, wherein the one or more mobile communication devices, such as the mobile communication device 104, each include data processing hardware 110 and data memory 112 therein. Furthermore, the book arrangement 100 includes a sensor arrangement 114 for detecting a given page, or a portion of a given page, of the printed book 102 being viewed or read by a user and generating corresponding sensed data.

Throughout the present disclosure, the term “mobile communication device” relates to an electronic device associated with (or used by) a user that is capable of enabling the user to perform specific tasks associated with the aforementioned book arrangement 100. Furthermore, the mobile communication device is intended, for example, to be broadly interpreted to include any electronic device that may be used for voice and/or data communication over a wireless communication network. Examples of mobile communication device include, but are not limited to, cellular phones, personal digital assistants (PDAs), handheld devices, wireless modems, laptop computers, personal computers, tablets, projectors, interactive screens, television sets, wearable items, for example watches, glasses, sunglasses and bracelets. Moreover, the mobile communication device may alternatively be referred to as a mobile station, a mobile terminal, a subscriber station, a remote station, a user terminal, a terminal, a subscriber unit, an access terminal. Additionally, for example, the mobile communication device is to be construed broadly, so as to encompass a variety of different types of mobile stations, subscriber stations or, more generally, communication devices, including examples such as a combination of a data card inserted in a laptop. Additionally, optionally, the mobile communication device may include a gaming console (such as, a PlayStation®, Xbox®, Nintendo®, and so forth) wherein the gaming console, including a media centre, handheld controllers, is paired with a monitor (operable to function as a graphical user interface). Furthermore, the media centre and the handheld controller may be operable to be used in combination with the printed book.

Throughout the present disclosure, the term “remote database arrangement” relates to an organized body of digital information regardless of the manner in which the data or the organized body thereof is represented. Optionally, the remote database arrangement may be, for example, hardware, software, firmware and/or any combination thereof. For example, the organized body of related data may be in the form of a table, a map, a grid, a packet, a datagram, a file, a document, a list, an image or in any other form; optionally, the organized body of related data includes a plurality of such items. The remote database arrangement includes, but is not limited to, any data storage software and systems, such as, a relational database like IBM DB2® and Oracle 9®. Furthermore, the remote database arrangement may include a database management system referring to the software program for creating and managing one or more databases. Additionally, the database is populated by data elements. Furthermore, the data elements may include, but are not limited to, data records, bits of data, cells, are used interchangeably herein and all intended to mean information stored in cells of a database.

Throughout the present disclosure, the term “data communication network” relates to an arrangement of interconnected programmable and/or non-programmable components that are configured to facilitate data communication between one or more mobile communication devices and/or remote database arrangement, whether available or known at the time of filing or as later developed. Furthermore, the data communication network may include, but is not limited to, one or more a peer-to-peer network, a hybrid peer-to-peer network, local area networks (LANs), radio access networks (RANs), metropolitan area networks (MANS), wide area networks (WANs), all or a portion of a public network such as the global computer network known as the Internet®, a private network, a cellular network and any other communication system or systems atone or more locations. Additionally, the data communication network includes wired or wireless communication that can be carried out via any number of known protocols including, but not limited to, Internet Protocol (IP), Wireless Access Protocol (WAP), Frame Relay, or Asynchronous Transfer Mode (ATM). Moreover, any other suitable protocols using voice, video, data, or combinations thereof, can also be employed.

Throughout the present disclosure, the term “data processing hardware” relates to a computational element that is operable to respond to and processes instructions. Optionally, the data processing hardware may include a data processor. Examples of the data processor includes, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit. Furthermore, the term “data processing hardware” may refer to one or more individual data processors, data processing devices and various elements associated with a data processing device that may be shared by other data processing devices. Additionally, the one or more individual data processors, data processing devices and elements are arranged in various architectures for responding to and processing the aforementioned instructions.

Throughout the present disclosure, the term “data memory” relates to a volatile or persistent medium, such as an electrical circuit, a magnetic disk, or an optical disk, in which a processing device may store data or software for any duration. Optionally, the data memory is non-volatile mass storage such as physical storage media. Furthermore, in a scenario wherein the data processing hardware is spatially distributed, the processing, memory and/or storage capability may be spatially distributed as well.

Throughout the present disclosure, the term “sensor arrangement” relates to an arrangement of hardware, software, firmware and/or any combination thereof for detecting a given page of the printed book. Optionally, the sensor arrangement may comprise, namely include as a component part thereof, thin film capacitors. Furthermore, the sensor arrangement may be operable to detect a proximity of the printed book with respect to the one or more mobile communication devices. Additionally, the sensor arrangement may be operable to detect a touch of the given user on the printed book. In addition, the sensor arrangement may be employed on the printed book and/or the one or more mobile communication devices. Optionally, a part of the sensor arrangement may be employed on the printed book and a complementary part thereof may be employed on the mobile communication device. Moreover, operation of the sensor arrangement may be described in detail herein later.

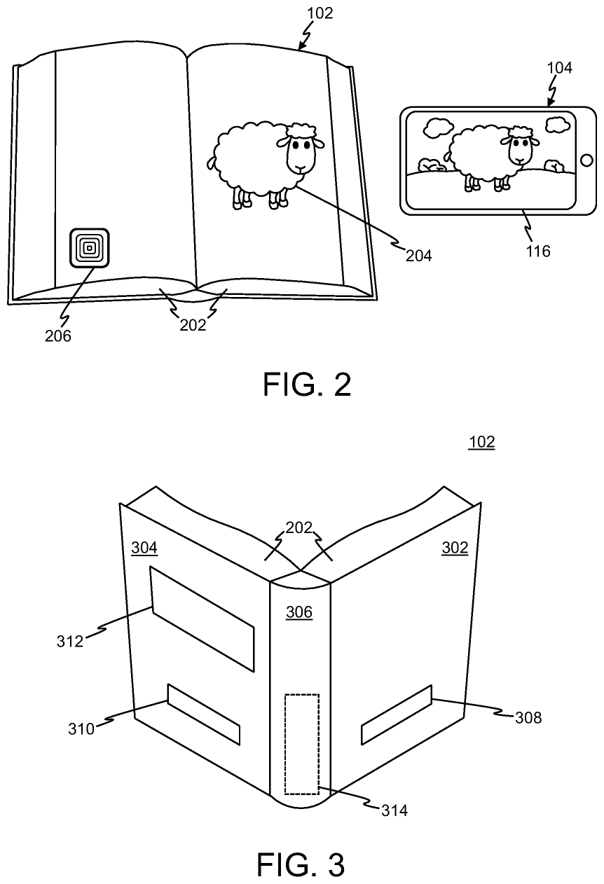

Referring to FIG. 2, there is shown an illustration of an implementation of the book arrangement (such as the book arrangement 100 of FIG. 1), in accordance with an embodiment of the present disclosure. As shown, the printed book 102 comprises a plurality of pages 202 for providing primary content, such as an illustration 204 of a sheep printed thereon.

Optionally, the primary content may include, but is not limited to, text, pictures, drawings, illustrations. In an example, the primary content may include text and images promoting teachings of harmony and respect between people. In another example, the primary content may include a questionnaire that may be answered by the user of the printed book. Optionally, the primary content may include character merchandising images.

The mobile communication device 104 comprises data processing hardware and data memory (such as the data processing hardware 110 and the data memory 112 of FIG. 1). Furthermore, the mobile communication device 104 comprises a graphical user interface (GUI)

116. The sensor arrangement (such as the sensor arrangement 114 of FIG. 1) is operable to detect a given page of the printed book 102 being viewed and/or read by the user and generate corresponding sensed data.

Specifically, the corresponding sensed data is indicative of the page being read and/or viewed by the user.

The data processing hardware 110 (of FIG. 1) and the data memory 112 (of FIG. 1) of the one or more mobile communication device, such as the mobile communication device 104, is configured to process the sensed data to determine the given page (namely, the page being read or viewed by the user), for example a portion of the given page, and to fetch corresponding supplementary content from the data memory 112 and/or the remote database arrangement 106 (of FIG. 1); alternatively, optionally, the corresponding supplementary content is pre-loaded into memory of the mobile communication device 104. The supplementary content is presented to the user on the graphical user interface (GUI)

116 of the mobile communication device 104. Specifically, the supplementary content is presented to enhance experience (namely, interest and enjoyment) of the user viewing/or reading the printed book 102. Moreover, the supplementary content may assist in reading and/or viewing of the printed book 102. Optionally, the supplementary content may be interactive wherein the user may be required to provide various inputs via the graphical user interface (GUI) 116 and present corresponding responses to the inputs. In an example, the supplementary content for the illustration 204 of the sheep (namely, primary content) may include an image or a video of a sheep or a game featuring a sheep in a grassy field to simulate an environment for the sheep. In another example, the supplementary content for a questionnaire (namely, primary content) may include answerable options for questions of the questionnaire presented on the graphical user interface (GUI). In such an example, the user may choose one of the answerable options for questions in the questionnaire, using the graphical user interface, to receive a final assessment of the questionnaire. In yet another example, the primary content of the printed book may include a complex puzzle to be solved by the user. In such example, the user may access supplementary content, for the complex puzzle on the mobile communication device, that may include suggestions or assistance in solving the complex puzzle. Examples of the supplementary content may include, but are not limited to, text, image, audio, video, game and/or any combination thereof. Optionally, the supplementary content may include a copy of the primary content that may be digitally presented on the mobile communication device 104.

The book arrangement of the present disclosure provides an enhanced experience to a given user by combining the physical and aesthetic experience of a conventional printed book with interactability of an electronic medium (such as the mobile communication device). Specifically, the given user may be capable to hold the printed book 102 physically, to turn pages of the printed book 102, and to write onto the printed book 102. Furthermore, the given user may experience interactability provided by the electronic medium (such as, to write digitally onto a page of the book, to increase or to decrease a size of a text of the book, to play audio or video content during reading of the book) via one or more mobile communication devices, such as the mobile communication device 104.

Throughout the present disclosure, the term “graphical user interface” (GUI) relates to a structured set of user interface elements rendered on a display screen. Optionally, the user interface rendered on the display screen is generated by any collection or set of instructions executable by an associated digital system. Additionally, the user interface (UI) is operable to interact with the user to convey graphical and/or textual information and receive input from the user. Specifically, the user interface used herein is a graphical user interface (GUI), for example as aforementioned. Furthermore, the user interface elements refer to visual objects that have a size and position in the graphical user interface. A user interface element may be visible, though there may be times when a user interface element is hidden. A user interface control is considered to be a user interface element. Text blocks, labels, text boxes, list boxes, lines, and images windows, dialog boxes, frames, panels, menus, buttons, icons, etc. are examples of user interface elements. In addition to size and position, a user interface element may have other properties, such as a margin, a spacing, or the like.

Optionally, in operation, the user of the printed book 102 may download at least one software application onto the mobile communication device 104. In an example, the software application may be developed (or, provided) by a publisher and/or an author of the printed book 102. In another example, the software application may be an application developed by an independent developer and/or an independent organization, wherein the software application may not be intended solely to be used with the printed book 102. Examples of such software applications may include, but are not limited to, social networking software applications (such as Facebook®, Whatsapp®, Twitter®, Instagram®, Snapchat® and so forth), audio/video players, gaming applications and so forth. The at least one software application downloaded on the mobile communication device 104 is operable to render at least a portion of the supplementary content (corresponding to the primary content) via the graphical user interface 116. Optionally, the supplementary content (or, a portion thereof) may be accessed by the data processing hardware 110 in real time from the remote database arrangement 106. Additionally or alternatively, optionally, the supplementary content may be pre-downloaded on the data memory 112 of the mobile communication device 104.

In an optional example embodiment, the sensor arrangement includes a coil arrangement for detecting resonances by electromagnetically interrogating one or more resonant circuits, for example including an inductor and a capacitor (for example, implemented as a planar printed inductor and a thin-film planar capacitor (“thin” film in this case means a capacitor have a dielectric film having a thickness in a range of 0.1 □m to 1.0 mm), such as the resonant circuit 206, included on the one or more pages, wherein the one or more resonant circuits are indicative of supplementary content being available for regions of pages of the printed book 102 whereat the one or more resonant circuit are included. Specifically, one or more pages of the printed book 102 may include one or more resonant circuits, such as the resonant circuit 206. More specifically, such resonant circuit 206 is indicative of availability of supplementary content (which may be accessed by the user) corresponding to the page wherein the resonant circuit is included. Furthermore, the coil arrangement may detect resonance electromagnetically for interrogating one or more resonant circuits. Moreover, the sensor arrangement may generate a sensed data corresponding to the page wherein the one or more resonant circuit is provided. Use of resonant coil arrangements has certain advantages in comparison to optical sensing in that operation of resonant coil arrangements is more resistant to surface contamination, for example arising from smears, spills and discolouration. Such resonant coil arrangements, for example, remain operational, even if children have used pencils and crayons to deface printed graphical contents of a given book. Optionally, a combination of optical sensing and resonant inductive circuit sensing is used for supplying supplementary content, to provide a more robust implementation for users, for example for physically destructive young children. When optical sensing fails, resonant circuit sensing can be used as a manner of keeping the printed book 102 functional in respect of reliably supplying supplementary content. Optionally, it will be appreciated that embodiments of the present disclosure only employ optical sensing for selecting and providing the supplementary content. Optionally, it will be appreciated that embodiments of the present disclosure only employ resonant inductive sensing for selecting and providing the supplementary content. Yet more optionally, it will be appreciated that embodiments of the present disclosure employ a combination of resonant inductive sensing and optical sensing for selecting and providing the supplementary content.

In an example embodiment, the sensor arrangement 114 is configured to employ one or more image sensors (not shown) (for example, an inbuilt camera) of the one or more mobile communication devices, such as the mobile communication device 104, for providing the sensed data, wherein the data processing hardware 110 and the data memory 112 of the one or more mobile communication devices is configured to compare the sensed data against reference data to determine the given page. Specifically, a page of the printed book 102 may comprise a resonant circuit 206 indicating the availability of supplementary content therefor. Subsequently, the user may capture an image of the page (or, a portion thereof) using one or more image sensors (namely, cameras) of the mobile communication device 104. Consequently, corresponding sensed data (namely, image data) is generated. The data processing hardware

110 may access the reference data from the data memory 112 and/or the remote database arrangement 106. Specifically, the reference data may include, but is not limited to, information relating to the primary content of the printed book 102, location of the primary content on the plurality of pages 202 and so forth. Consequently, the data processing hardware 110 may compare sensed image data and the reference data to generate a spatial correlation there between. Therefore, the data processing hardware 110 may obtain a spatial correlation from comparison and yield an output correlation, thereby determining a page. being read and/or viewed by the user. Subsequently, the data processing hardware 110 may provide the supplementary content, corresponding to the page being read and/or viewed by the user, to the mobile communication device 104 of the user. Consequently, the supplementary content may be displayed on the graphical user interface of the mobile communication device 104.

It will be appreciated that the supplementary content may be fetched depending upon image recognition implemented via the mobile communication device 104, or by recognition based upon interrogation of one or more resonant circuits by employing a coil arrangement incorporated into the printed book 102. Yet alternatively, the mobile communication device 104 is provided with an attachment, for example a clip-on accessory, (for example, coupled via wireless near-field-radio (NFR) communication, for example via Bluetooth® to the mobile communication device 104), that the user holds in close proximity to the one or more resonant circuits for sensing their presence in the printed book 104, for use in generating the sensor signal for requesting presentation of corresponding supplementary content on the graphical user interface (GUI). The one or more resonant circuits optionally have resonant frequencies in a range of 30 kHz to 1 MHz, more optionally in a range of 50 kHz to 150 kHz.

In an example embodiment, the data processing hardware 110 and the data memory 112 of the one or more mobile communication devices, such as the mobile communication device 104, is configured to compare the sensed data against reference data to determine the given page, by comparing metadata describing the sensed data against reference metadata. Specifically, metadata describing the sensed data may comprise data (or, a set of data) describing the primary content, location of primary content on the plurality of pages 202 (for example, a page number) and so forth. Similarly, the reference metadata stored in the data memory 112 (or, in remote database arrangement 106) may comprise data (or, a set of data) describing the primary content, location of primary content on the plurality of pages 202 (for example, a page number) and so forth. In an example, sensed image data of primary content located on a specific page of a printed book may be converted into metadata in a binary format. In such example, image data of primary content of the printed book may be stored in the data memory as a reference metadata in binary format. Consequently, the data processing hardware 110 may compare the metadata in binary format to determine the given page.

In an example embodiment, the one or more resonant circuits, such as the resonant circuit 206, are implemented by employing inductors that are fabricated by using printed conductive ink or conductive polymer. Specifically, the resonant circuit 206 may be implemented by using conductive ink (or, conductive polymer) to provide electrical conduction in the plurality of printed pages. More specifically, the coils printed using conductive ink are arranged to be resonant circuits by adding, for example thin-film capacitors (or, inductors) thereto. Optionally, the printed coils may be overprinted with opaque insulating ink to mask the printed coils. Furthermore, the resonant circuits may be tuned to unique mutually different frequencies on different pages. Therefore, the sensor arrangement 114 may detect a resonant frequency of a resonant circuit 206 of a given page. Consequently, the data processing hardware 110 may determine the given page from the resonant frequency thereof. Optionally, the primary content, such as the illustration 204 of the sheep, may be printed using conductive ink (or, conductive polymer) and resonant circuits may be implemented thereon.

In an example embodiment, the one or more resonant circuits are implemented by using one or more labels including the one or more resonant circuits, wherein the one or more labels are adhesively attachable to the plurality of pages 202 and/or at least one of a front cover and back cover of the printed book, for example as aforementioned. Specifically, the resonant circuit 206 may be adhesive-backed label that may be attached to the plurality of pages 202. More specifically, the resonant circuit is implemented for the pages that have supplementary content available therefor. Optionally, the adhesive back label may have printings thereon. Examples of the adhesive-back labels include, but are not limited to, RFID tags, QR codes, barcodes, and electronic identification tags. The sensor arrangement 114 may detect the label and generate sensed data corresponding to the page wherein the label is included. Furthermore, the one or more resonant circuit implemented using one or more adhesive-backed labels may be used in combination with one or more resonant circuits implemented using conductive ink (or, conductive polymer).

In an embodiment, the one or more resonant circuits may be implemented using one or more detachable labels, for example one detachable label. Specifically, the detachable label may be secured between pages of the printed book 102, when the book is in a closed state. Optionally, the detachable label may be attached to one or more pages of the printed book 102. Furthermore, the detachable label may be manufactured using paper, cardboard, wood, metal, and so forth at least.

Referring to FIG. 3, there is shown a schematic illustration of the printed book 102, in accordance with an embodiment of the present disclosure. The printed book 102 is useable with the book arrangement 100. As described, the printed book 102 comprises a plurality of pages 202. Furthermore, the printed book 102 comprises a front cover 302, a back cover 304 and a spine region 306. The plurality of pages 202 are bound to the spine region 306 and protected between the front cover 302 and back cover 304 of the printed book 102. Moreover, optionally, when in a closed state, principal planes of the front cover 302 and back cover 304 may lie in a substantially parallel configuration (wherein, parallel may lie within an error margin of +5° to −5°). Furthermore, the front cover 302 and back cover 304 may be flexible (for example, a soft cover), stiff (for example, hardbound covers) or a combination thereof. Examples of the printed books include, but are not limited to, hardcover books, paperback books, spiral-bound books, periodicals, magazines, journals, comic book, leaflets and so forth.

In an example embodiment, the front cover 302 and/or the back cover 304 of the printed book is manufactured from at least one of following materials: leather, faux leather, suede, moleskin, plastic, velvet; these materials are flexible and some include fibres with voids there between. Moreover, such materials can also be very absorbant to solvents employed in inks, when such inks are used for printing onto the materials. Furthermore, some of the materials are not porous that makes ink adhesion difficult, namely relying solely on Van de Waals forces to retain ink onto some of the aforesaid materials, rather than achieving a mechanical keying of inks into surface voids of the materials.

Furthermore, the method includes implementing printing on the front cover 302 and/or back cover 304 using conductive ink, wherein front and back cover of the printed book are manufactured using at least one of: leather, suede, moleskin, plastic, velvet. Specifically, the printing technique used for the implementation of ink and/or conductive ink on the front cover 302 and back cover 304 may preserve (namely, not damage) the material of the front cover 302 and/or back cover 304. In an event that an adhesion of the printed ink onto the front cover 302 and/or back cover 304 is sub-optional, microcracking of the printed ink can occur, for example in an event that the front cover 302 and/or back cover 304 are subject to considerable repeated flexure when in use.

In an example embodiment, the technique used for the manufacturing of the printing technique may be operable to enable adhesive attachment of one or more labels (such as a detachable label) on the front cover 302 and/or back cover 304 of the printed book 102. Specifically, the material (such as suede, moleskin, velvet) used for manufacture of the front cover 302 and/or back cover 304 of the printed book 102 may not allow prolonged adhesive attachment of one or more labels thereon. More specifically, the one or more labels attached to the front cover 302 and/or back cover 304 may detach, after a certain period of time, due to material thereof.

In an example embodiment, the adhesive used for attachment of one or more labels to front cover 302, back cover 304 and the plurality of pages 202 may allow durable attachment and easy detachment thereof. Furthermore, adhesive may be able to withstand multiple attachments and detachments. By employing adhesives, it is feasible to dissipate flexural strain within the adhesive layer, for example via creep of the adhesive layer, rather than attempting to absorb the strain within the printed ink.

In an embodiment, a curing technique used for implementation of ink (optionally, conductive ink) may be performed using ultraviolet light and/or infrared heat. Furthermore, the curing technique may preserve the material of the front cover 302, back cover 304 and the plurality of pages 202. Additionally, the curing technique used may increase durability and longevity of the ink, for example by causing long-chain polymerization of the ink whilst retaining flexibility. Moreover, the temperature during the manufacture of the printed book 102 may be controlled in a certain range to preserve the material of the front cover 302 and/or back cover 304. Long-chain polymerization also renders the printed ink less prone to cracking and flaking, wherein long-chain polymer chains improve an abrasion performance of the printed inks. By polymerization after printing allows for freshly-printed ink to penetrate into a material's micro-voids before being coupled by polymerization to ink molecules on an outer surface of the material, improves reliability of the printed ink considerably. As aforementioned, such long-chain polymerization can be achieved by thermal exposure, electromagnetic radiation exposure (for example, UV curing), or by charged-particle beam curing (for example, electron beam curing) or neutral-charge particle beam curing (for example, neutron beam curing), or any combination of such exposure. Such long-chain polymerization processes can be applied simultaneously to the conductive ink, or in series as a sequential manner of curing the conductive ink.

In an example embodiment, the front cover 302 and the back cover 304 are optionally provided with a coil arrangement, such as coil arrangements 308 and 310, for interrogating the one or more resonant circuits (such as the resonant circuit 206 of FIG. 2), to determine the given page at which the printed book 102 is open when in use. Specifically, the coil arrangements 308 and 310 may assess the pages closer to the front cover 302 and/or back cover 304 by measuring intensity of the resonant frequencies, emanated from the one or more resonant circuits included on the pages for which supplementary content is available. In an example, the one or more resonant circuits may only be included on evenly numbered pages (for example, pages 2, 4, 6 and so forth) of a printed book. In such example, after reading an oddly numbered page (for example, page numbered 5); the user may turn to an evenly numbered page (namely, page numbered 6). In such scenario, after turning the page, a resonant circuit included on the evenly numbered page (namely, page numbered 6), may get closer to the coil arrangement on the front cover in comparison to before the page was turned. Similarly, after turning the page, the resonant circuit included on the evenly numbered page (namely, page numbered 6), may get farther from the coil arrangement on the back cover in comparison to before the page was turned. Therefore, the intensity of resonant frequencies of the evenly numbered page (namely, page numbered 6) may increase with respect to the coil arrangements on the front cover and may decrease with respect to the coil arrangements on the back cover.

In an embodiment, the printed book 102 includes a local data processing hardware 312 for exciting the coil arrangement, such as the coil arrangements 308 and 310, for interrogating the one or more resonant circuits (such as the resonant circuit 206 of FIG. 2), and for communicating the sensed data to the one or more mobile communication devices, such as the mobile communication device 104 (of FIG. 1). Specifically, the local data processing hardware 312 may provide electrical energy to the coil arrangements 308 and 310 for excitation thereof. More specifically, the coil arrangements 308 and 310 may communicate with the local data processing hardware 312. Moreover, the local data processing hardware 312 may be hardware, software, firmware or any combination thereof operable to process information provided by the coil arrangements 308 and 310. Furthermore, the local data processing hardware 312 is operable to process information provided by the coil arrangements 308 and 310 and determine therefrom the page being read and/or viewed by the user. Optionally, the local data processing hardware 312 may be connected with the one or more resonant circuits implemented on the plurality of pages 202 of the printed book 102. Specifically, the local data processing hardware 312 may be connected to one or more resonant circuits implemented using adhesive-backed labels and conductive ink (or, conductive polymer). Optionally, the user may be provided with a pointing object (such as, a metallic pen). Consequently, the user may use the pointing object to point at a specific location of a given page on the printed book 102. Subsequently, the local data processing hardware 312 is operable to detect the spatial location where the pointing object is pointed and determine the given page and the location on the page being read and/or viewed by the user. In an example, the one or more resonant circuits (or, the primary content) on the plurality of pages 202 may be printed using conductive ink (or, conductive polymer). In such example, the user may point (namely, touch) one or more resonant circuits (or, primary content) of the printed book 102 using the pointing object. Therefore, the one or more resonant circuits (or, primary content) connected with the local data processing hardware 312 using conductive ink may detect location where the pointing object is pointed and determine the given page and the location on the page being read and/or viewed by the user; for example, bringing a metallic object close to a given resonant circuit will influence a Q-factor of resonance, and/or a resonant frequency of the given resonant circuit, and such a change can be used in the book arrangement 100 to sense that the given user is using the metallic object to point at a given portion of a page to which the resonant circuit is attached or integrally incorporated. Beneficially, the user may use the pointing object for identifying the primary content for which the corresponding supplementary content is desired. Optionally, the local data processing hardware 312 (or, a portion thereof) may be included on the front cover 302, back cover 304 and/or spine region 306.

In an example embodiment, the local data processing hardware 312 may be operable to detect a location of the detachable label. Specifically, the local data processing hardware 312 may detect the page on which the detachable label has been included or secured. Furthermore, the user may be operable to make one or more changes to the detachable label. In an example, the user may write on the detachable label. In another example, the detachable label may be a paper doll. In such example, the user may paste clothing items, accessories and so forth on the paper doll. Consequently, the local data processing hardware 312 may be operable to detect such changes made to the detachable label. Furthermore, the detachable label may be operable to interact with the coil arrangement 308 and 310.

In an example embodiment, as aforementioned, the resonant frequency and/or a Q-factor of one or more resonant circuits printed on the plurality of pages 202 may be altered slightly due to presence of mobile communication device 104 of the user nearby. Consequently, the local data processing hardware 312 may detect the alteration in the resonant frequency (and/or the Q-factor) and detect the page being read and/or viewed by the user. Beneficially, the user may place the mobile communication device thereof near the resonant circuit of the page for which supplementary content is desired.

In an example embodiment, the printed book 102 includes a wireless interface 314 for communicating the sensed data to the one or more mobile communication devices, such as the mobile communication device 104. Specifically, the wireless interface may be coupled to the mobile communication device 104 using a near-field wireless communication network. Optionally, the sensor arrangement (specifically, coil arrangements 308 and 310) and the local data processing hardware 312 may communicate with the mobile communication device 104 using a wired connection therewith. Examples of the near-field wireless communication network include, but are not limited to, Bluetooth®, Near Field Communication (NFC), Wi-Fi®, Li-Fi®, Zigbee®. Furthermore, sensed data from the sensor arrangement (specifically, coil arrangements 308 and 310) and the local data processing hardware 312 is communicated to the mobile communication device 104 using the wireless interface 314. Moreover, sensed data may include data sensed by the coil arrangements 308 and 310 and/or data processed by the local data processing hardware 312. For example, the wireless interface may communicate information relating to intensity of resonant frequencies of one or more resonant circuits to the mobile communication device. Consequently in such example, the data processing hardware of the mobile communication data may process the information to determine a page being read and/or viewed by the user. Thereafter, the data processing hardware of the mobile communication data may present supplementary content, corresponding to such page, on the graphical user interface (GUI) thereof. In another example, the local data processing hardware of the printed book may communicate the data relating to the page being read and/or viewed by the user to the mobile communication device. Consequently, in such example, the data processing hardware of the mobile communication data may present supplementary content, corresponding to such page, on the graphical user interface (GUI) thereof. In yet another example, the local data processing hardware of the printed book may communicate data related to the detachable label to mobile communication device. Specifically, the data related to the detachable label may include location of the detachable label, changes made to the detachable label and so forth. Consequently, in such example, the mobile communication device may display supplementary content related to the detachable label, or may estimate a location of the page being read by the user.

In an embodiment, the wireless interface 314 of the printed book 102 is housed within a spine region 306 of the printed book 102. Specifically, the wireless interface 314 may be a hardware element, such an integrated circuit (IC) chip, which may be included in the binding of the spine region 306 of the printed book 102. Optionally, the wireless interface 314 may be included between the spine region 306 and the plurality of pages 202. More optionally, the wireless interface may be included on the front cover 302 or the back cover 304.

In an example embodiment, the printed book 102 may include a rechargeable battery unit (not shown). Moreover, such rechargeable battery unit may be arranged to be charged via a resonant inductive charging and/or via conventional wired charging. Optionally, the user may place the printed book 102 on a charging mat driven by an electronic oscillator that is energized via a power supply unit coupled to a power grid connection or a renewable energy power sources (for example, solar cells). Alternatively, or additionally, the printed book 102 is provided with an electrical connection for connected to a recharging unit (for example, a miniature USB connector or similar).

Optionally, one or more mobile communication device of a plurality of users may be mutually coupled together via a data communication network wherein an interface for interaction between the plurality of users may be provided on the at least one software application onto the one or more mobile communication devices thereof. Furthermore, the plurality of user may have corresponding printed books in operation, interacting with their corresponding mobile communication devices with their associated graphical interface unit (GUI), and the mobile communication devices are operable to share information there between, so that the plurality of user are able mutually to interact in real-time regarding their reading and appreciation of the printed book. For example, such an implementation allows for group tuition and group sharing of experiences, preferences and interests in real-time.

In an example embodiment, the supplementary content corresponding to the primary content of the printed book 102 may be temporally updated. Specifically, in an event of repeated viewing and/or reading of the book, the local data processing hardware 312 and/or the data processing hardware 110 of the mobile communication device 104 may be operable to detect such repeated viewing and/or reading and may present updated supplementary content to the user. Consequently, the experience of the user may not be diminished on repeated viewing and/or reading of the printed book. Moreover, the supplementary content may be updated temporally by the provider of the supplementary content.

In an example embodiment, the user may be operable to render changes to the supplementary content, corresponding to the primary content on the printed book 102, using the one or more mobile communication device. Optionally, the user may draw and/or write on the supplementary content (or, a portion thereof). Furthermore, the user may render changes to the supplementary content and may share such changes on social media platforms. In an example, the supplementary content may include photo filters which may be overlayed (overlaid) onto an object. In such example, the user may capture an image using the image sensors of the mobile communication device. Subsequently, the user may overlay such photo filters on the captured image and may share on social media platforms.

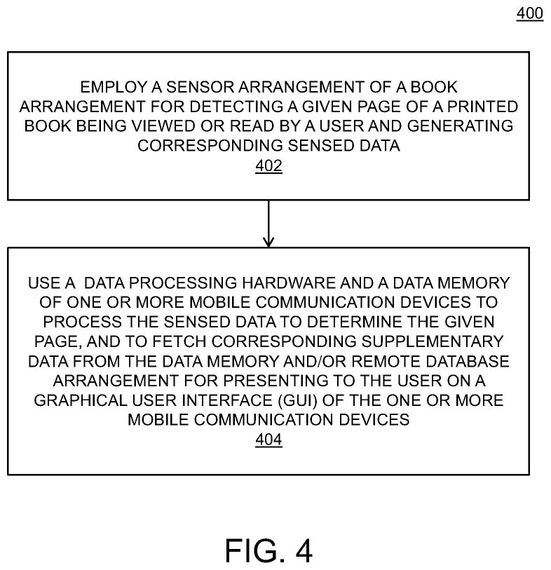

Referring to FIG. 4, there is shown an illustration of steps of method 400 of using a book arrangement (such as the book arrangement 100 of FIG. 1), in accordance with an embodiment of the present disclosure. The book arrangement includes a printed book having a plurality of printed pages for providing primary content, one or more mobile communication devices, and a remote database arrangement couplable via a data communication network to the one or more mobile communication devices, wherein the one or more mobile communication devices each include data processing hardware and data memory therein. At a step 402, a sensor arrangement of the book arrangement is employed for detecting a given page of the printed book being viewed or read by a user and generating corresponding sensed data. At a step 404, the data processing hardware and the data memory of the one or more mobile communication devices is used to process the sensed data to determine the given page, and to fetch corresponding supplementary content from the data memory and/or the remote database arrangement for presenting to the user on a graphical user interface (GUI) of the one or more mobile communication devices.

The steps 402 to 404 are only illustrative and other alternatives can also be provided where one or more steps are added, one or more steps are removed, or one or more steps are provided in a different sequence without departing from the scope of the claims herein. Optionally, the method 400 includes configuring the sensor arrangement to employ one or more image sensors of the one or more mobile communication devices for providing the sensed data, wherein the data processing hardware and the data memory of the one or more mobile communication devices is configured to compare the sensed data against reference data to determine the given page. Optionally, the method 400 includes configuring the data processing hardware and the data memory of the one or more mobile communication devices to compare the sensed data against reference data to determine the given page, by comparing metadata describing the sensed data against reference metadata. More optionally, the method 400 includes arranging for the sensor arrangement to include a coil arrangement for detecting resonances by electromagnetically interrogating one or more resonant circuits included on the one or more pages, wherein the one or more resonant circuits are indicative of supplementary content being available for regions of pages of the printed book whereat the one or more resonant circuit are included. Yet more optionally, the method 400 includes implementing the one or more resonant circuits by employing inductors that are fabricated by using printed conductive ink or conductive polymer.

In an example embodiment, the method 400 includes implementing the one or more resonant circuits by using one or more labels including the one or more resonant circuits, wherein the one or more labels are adhesively attachable to the plurality of pages and/or at least one of a front cover and back cover of the printed book, for example during manufacture of the printed book. In another example, the method 400 includes arranging for the printed book to have a front cover and a back cover provided with the coil arrangement for interrogating the one or more resonant circuits, to determine the given page at which the printed book is open when in use. In yet another example, the method 400 includes arranging for the printed book to include local data processing hardware for exciting the coil arrangement for interrogating the one or more resonant circuits, and for communicating the sensed data to the one or more mobile communication devices. Optionally, the method 400 includes arranging for the printed book to include a wireless interface for communicating the sensed data to the one or more mobile communication devices. More optionally, the method 400 includes housing the wireless interface of the printed book within a spine region of the printed book.

Furthermore, there is disclosed a software product recorded on machine-readable non-transient data storage media, wherein the software product is executable upon computing hardware to implement a method of using a book arrangement (such as the book arrangement 100 of FIG. 1). Moreover, the machine-readable non-transient data storage media comprises one of a floppy disk, a hard disk, a high capacity read only memory in the form of an optically read compact disk or CD-ROM, a DVD, a tape, a read only memory (ROM), and a random access memory (RAM). Additionally, the software product includes instructions executed by a computer system to cause the computer system to perform the steps of the method 400 (of FIG. 4) of using the book arrangement.

The present disclosure provides the book arrangement and method of using the aforementioned book arrangement. The book arrangement of the present disclosure has characteristics of a book printed on paper, but is configured to provide interactive electronic functionality to a given user of the book arrangement; the printed book provides an element of “ownership” to the given user, and the printed book is operable to provide access to the supplementary content that, for example, is dynamically temporally changing to provide the given user with enhanced excitement and interest. Thus, the book arrangement is of benefit in that an operation of appreciating a given portion of the printed book and subsequently experiencing the corresponding supplementary content (or, at least a portion thereof) on the one or more mobile communication devices, provides enhanced interest and enjoyment for the user, for example as aforementioned. Furthermore, the supplementary content may be interactive with the user requiring various inputs therefrom via the graphical user interface and presenting corresponding responses. Additionally, optionally, the supplementary content may be temporally changeable to provide better experience to the user, on repeated reading of the printed book, for example as aforementioned.

Optionally, the remote database arrangement 106 employs adaptive algorithms, for example implemented using a hierarchical arrangement of pseudo-analog variable-state-machines implemented in software, that are provided with historical data representative of browsing patterns of a given user in the printed book 102, and selects the supplementary content, at least partially, depending on the historical data; such pseudo-analog variable-state-machines are able to provide a closest facsimile to human cognitive brain operation, and therefore is able to provide an improved human-type interface to a reader of the printed book 102. Such adaptive and temporally changing selection of the supplementary information is capable of providing enhanced user enjoyment and stimulation, assisting to maintain the given user's interest in reading the printed book 102 frequently. For example, the supplementary content is selectively chosen to avoid the given user becoming limited to a small variety of browsing patterns; such an approach is beneficial to address autistic invariant browsing patterns that may be exhibited by children with autistic tendencies. The printed book 102 and its associated method of operation is therefore capable of being used for therapeutic purposes with children suffering, at least in part, from autism.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1.-26. (canceled)

27. A book arrangement including a printed book having a plurality of printed pages for providing primary content, one or more mobile communication devices, and a remote database arrangement couplable via a data communication network to the one or more mobile communication devices, wherein the one or more mobile communication devices each include data processing hardware and data memory therein, wherein the book arrangement includes a sensor arrangement for detecting a given page of the printed book, or a portion of a given page of the printed book, being viewed or read by a user and generating corresponding sensed data, wherein the data processing hardware and the data memory of the one or more mobile communication devices is configured to process the sensed data to determine the given page, or the portion of the given page of the printed book, and to fetch corresponding supplementary content from the data memory and/or the remote database arrangement for presenting to the user on a graphical user interface (GUI) of the one or more mobile communication devices.

28. A book arrangement of claim 27, wherein the sensor arrangement includes at least one of: optical sensors, resonant inductive sensors, graphical images readable using optical sensors, resonant inductive structures readable using resonant inductive sensors.

29. A book arrangement of claim 27, wherein the sensor arrangement is configured to employ one or more image sensors of the one or more mobile communication devices for providing the sensed data, wherein the data processing hardware and the data memory of the one or more mobile communication devices is configured to compare the sensed data against reference data to determine the given page, or the portion of the given page of the printed book.

30. A book arrangement of claim 29, wherein the data processing hardware and the data memory of the one or more mobile communication devices is configured to compare the sensed data against reference data to determine the given page, or the portion of the given page of the printed book, by comparing metadata describing the sensed data against reference metadata.

31. A book arrangement of any one of claim 27, wherein the sensor arrangement includes a coil arrangement for detecting resonances by electromagnetically interrogating one or more resonant circuits included on the one or more pages, wherein the one or more resonant circuits are indicative of supplementary content being available for regions of pages of the printed book whereat the one or more resonant circuit are included.

32. A book arrangement of claim 31, wherein the one or more resonant circuits are implemented by employing inductors that are fabricated by using printed conductive ink or conductive polymer.

33. A book arrangement of claim 31, wherein the one or more resonant circuits are implemented by using one or more labels including the one or more resonant circuits, wherein the one or more labels are adhesively attachable to the plurality of pages and/or at least one of a front cover and back cover of the printed book.

34. A book arrangement of any one of claim 31, wherein the printed book has at least one of the front cover and the back cover provided with the coil arrangement for interrogating the one or more resonant circuits, to determine the given page at which the printed book is open when in use.

35. A book arrangement of claim 34, wherein the printed book includes local data processing hardware for exciting the coil arrangement for interrogating the one or more resonant circuits, and for communicating the sensed data to the one or more mobile communication devices

36. A book arrangement of claim 35, wherein the printed book includes a wireless interface for communicating the sensed data to the one or more mobile communication devices.

37. A method of (for) using a book arrangement including a printed book having a plurality of printed pages for providing primary content, one or more mobile communication devices, and a remote database arrangement couplable via a data communication network to the one or more mobile communication devices, wherein the one or more mobile communication devices each include data processing hardware and data memory therein, wherein the method includes:
a. employing a sensor arrangement of the book arrangement for detecting a given page of the printed book, or a portion of a given page of the printed book, being viewed or read by a user and generating corresponding sensed data; and
b. using the data processing hardware and the data memory of the one or more mobile communication devices to process the sensed data to determine the given page, or the portion of the given page of the printed book, and to fetch corresponding supplementary content from the data memory and/or the remote database arrangement for presenting to the user on a graphical user interface (GUI) of the one or more mobile communication devices.

38. A method of claim 37, characterized in that the method includes arranging for the sensor arrangement to include at least one of: optical sensors, resonant inductive sensors, graphical images readable using optical sensors, resonant inductive structures readable using resonant inductive sensors.

39. A method of claim 37, wherein the method includes configuring the sensor arrangement to employ one or more image sensors of the one or more mobile communication devices for providing the sensed data, wherein the data processing hardware and the data memory of the one or more mobile communication devices is configured to compare the sensed data against reference data to determine the given page, or the portion of the given page of the printed book.

40. A method of claim 39, wherein the method includes configuring the data processing hardware and the data memory of the one or more mobile communication devices to compare the sensed data against reference data to determine the given page, or the portion of the given page of the printed book, by comparing metadata describing the sensed data against reference metadata.

41. A method of claim 38, wherein the method includes arranging for the sensor arrangement to include a coil arrangement for detecting resonances by electromagnetically interrogating one or more resonant circuits included on the one or more pages, wherein the one or more resonant circuits are indicative of supplementary content being available for regions of pages of the printed book whereat the one or more resonant circuit are included.

42. A method of claim 41, wherein the method includes implementing the one or more resonant circuits by employing inductors that are fabricated by using printed conductive ink or conductive polymer.

43. A method of claim 41, wherein the method includes implementing the one or more resonant circuits by using one or more labels including the one or more resonant circuits, wherein the one or more labels are adhesively attachable to the plurality of pages and/or at least one of a front cover and back cover of the printed book.

44. A method of claim 41, wherein the method includes arranging for the printed book to have at least one of the front cover and the back cover provided with the coil arrangement for interrogating the one or more resonant circuits, to determine the given page at which the printed book is open when in use.

45. A method of claim 41, wherein the method includes arranging for the printed book to include local data processing hardware for exciting the coil arrangement for interrogating the one or more resonant circuits, and for communicating the sensed data to the one or more mobile communication devices. wherein the method includes arranging for the printed book to include a wireless interface for communicating the sensed data to the one or more mobile communication devices.

46. A software product recorded on machine-readable non-transient data storage media, wherein the software product is executable upon computing hardware to implement a method of claim 37.
